(19) United States
(12) Patent Application Publication
(10) Pub. No.: US 2012/0081538 A1
(43) Pub. Date: Apr. 5, 2012

(54) PATTERN INSPECTION APPARATUS

(75) Inventors: Riki Ogawa, Kanagawa (JP); Masatoshi Hirono, Kanagawa (JP); Takeshi Nishizaka, Chiba (JP); Ryoichi Hirano, Tokyo (JP); Ikunao Isomura, Kanagawa (JP); Kazuto Matsuki, Tokyo (JP); Fumio Ozaki, Kanagawa (JP)

(73) Assignees: KABUSHIKI KAISHA TOSHIBA, Tokyo (JP); NuFlare Technology, Inc., Numazu-shi (JP)

(21) Appl. No.: 13/242,655

(22) Filed: Sep. 23, 2011

(30) Foreign Application Priority Data
Sep. 30, 2010 (JP) 2010-222430

(51) Int. Cl. H04N 7/18

(52) U.S. Cl. 348/87; 348/E07.085

(57) ABSTRACT

This pattern inspection apparatus includes an inspection region information storage unit that stores an inspection region specified in a pattern region, a pattern surface height detection unit that detects a pattern surface height signal corresponding to a pattern surface height measurement position on the inspection sample, an autofocus mechanism that focuses on the inspection sample using the pattern surface height signal detected by the pattern surface height detection unit, a determination unit, and an autofocus mechanism control unit. When the determination unit determines that the pattern surface height measurement position is located within the inspection region, the autofocus mechanism control unit drives the autofocus mechanism, and the determination unit determines that the pattern surface height measurement position is not located within the inspection region, the autofocus mechanism control unit stops the autofocus mechanism.

### CROSS-REFERENCE TO RELATED APPLICATION

This application is based upon and claims the benefit of priority from Japanese Patent Applications No. 2010-222430, filed on Sep. 30, 2010, the entire contents of which are incorporated herein by reference.

### FIELD OF THE INVENTION

The present invention relates to a pattern inspection apparatus for inspecting an inspection sample having a pattern formed thereon.

### BACKGROUND OF THE INVENTION

In recent years, the sizes of semiconductor patterns are significantly reduced. In general, a semiconductor is manufactured by reducing and projecting a pattern drawn on a mask onto a wafer. Accordingly, microprocessing of semiconductors is limited due to the effect of diffraction in a reduction projection optical system.

The minimum pattern size that can be supported by a reduction optical system is proportional to a wavelength of used light, and the minimum wavelength of the light sources used for semiconductor exposure apparatuses has now reached 193 nm. However, since there are few glass materials that can be used for a shorter wavelength optics, next generation exposure apparatus is considered to swiftly advance into use of extreme ultraviolet (EUV light) with a reflection optical system in vacuum.

However, this apparatus has many problems to be solved, and the cost is extremely expensive. In this circumstance, imprint lithography is considered as one of alternative ideas.

The principle of the imprint lithography is as follows. A glass mask engraved with a pattern of the same size as a semiconductor pattern is pressed onto an imprint resist, and the resist is cured with ultraviolet light and thereafter the mask is removed. In other words, the imprint lithography has the same principle as a stamp. Therefore, in a mask for imprint lithography, a pattern region protrudes from a non-pattern region in a periphery.

When the mask for imprint lithography is inspected by a mask defect inspection apparatus, the following problems will occur. In general, the mask defect inspection apparatus scans an inspection region with linear serpentine operation. In the pattern region to be inspected, the pattern is formed up to a portion very close to the edge of protruded region. Therefore, during mask run, a significant defocus occurs with respect to the mask surface at the edge of the protruded region, whose height is few tens to few hundreds of microns.

JP-A 2004-125411 discloses a height position adjustment method capable of adjusting a height of a sample surface in order to focus, even in an inspection of an inspection sample with a pellicle having a level difference portion on the sample surface.

### SUMMARY OF THE INVENTION

A pattern inspection apparatus according to a first aspect of the present invention is a pattern inspection apparatus configured to inspect an inspection sample using a pattern image obtained by emitting light onto the inspection sample having a pattern region having a pattern formed therein and a non-pattern region surrounding the pattern region and having no pattern formed therein, and the pattern inspection apparatus includes an inspection region information storage unit configured to store a positional information inspection region specified in the pattern region; a pattern surface height detection unit configured to detect a pattern surface height signal corresponding to a pattern surface height measurement position on the inspection sample; an autofocus mechanism configured to focus on the inspection sample using the pattern surface height signal detected by the pattern surface height detection unit; a determination unit configured to determine whether the pattern surface height measurement position is located within the inspection region or not; and an autofocus mechanism control unit, wherein, when the determination unit determines that the pattern surface height measurement position is located within the inspection region, the autofocus mechanism control unit drives the autofocus mechanism, and when the determination unit determines that the pattern surface height measurement position is not located within the inspection region, the autofocus mechanism control unit stops the autofocus mechanism.

A pattern inspection apparatus according to a second aspect of the present invention is a pattern inspection apparatus configured to inspect an inspection sample using a pattern image obtained by emitting light onto the inspection sample placed on a stage and having a pattern region having a pattern formed therein and a non-pattern region surrounding the pattern region and having no pattern formed therein, and the pattern inspection apparatus includes a height measuring unit configured to measure heights at three positions on a pattern surface formed by the pattern region; an inclination calculation unit configured to calculate an inclination of the pattern surface, from a measurement result provided by the height measuring unit; a correction value calculation unit configured to calculate a correction value to cause an inclination of the pattern surface and an inclination of the stage run surface to be the same, from a calculation result provided by the inclination calculation unit; and an inclination correction mechanism configured to cause the inclination of the pattern surface and the inclination of the stage run surface to be the same, using the correction value.

### BRIEF DESCRIPTION OF THE DRAWINGS

FIGS. 1A and 1B are schematic diagrams illustrating a configuration of an essential portion of the pattern inspection apparatus according to a first embodiment;

FIG. 2 is a figure illustrating an entire configuration of a pattern inspection apparatus according to the first embodiment;

FIG. 3 is an explanatory diagram illustrating inspection of the pattern inspection apparatus according to the first embodiment;

FIGS. 4A and 4B are explanatory diagrams illustrating a mask for imprint lithography serving as an inspection sample of the pattern inspection apparatus according to the first embodiment;

FIG. 5 is a figure illustrating a pattern inspection method according to the first embodiment;

FIGS. 6A and 6B are schematic diagrams illustrating a configuration of an essential portion of a pattern inspection apparatus according to a second embodiment; and

FIGS. 7A and 7B are schematic diagrams illustrating a configuration of an essential portion of a pattern inspection apparatus according to a third embodiment.

### DETAILED DESCRIPTION OF THE EMBODIMENTS

Hereinafter, embodiments of the invention will be explained with reference to the accompanying drawings.

In this specification, “mask surface” means a surface of a side of a mask on which a pattern is formed.

### First Embodiment

The pattern inspection apparatus according to the present embodiment is a pattern inspection apparatus for inspecting an inspection sample using a pattern image obtained by emitting light onto the inspection sample having a pattern region having a pattern formed therein and a non-pattern region surrounding the pattern region and having no pattern formed therein. In addition, the pattern inspection apparatus includes an inspection region information storage unit storing positional information of inspection region specified in a pattern region, a pattern surface height detection unit for detecting a pattern surface height signal corresponding to a pattern surface height measurement position on the inspection sample, an autofocus mechanism for focusing on the inspection sample using the pattern surface height signal detected by the pattern surface height detection unit, a determination unit for determining whether the pattern surface height measurement position is located within the inspection region or not, and an autofocus mechanism control unit. When the determination unit determines that the pattern surface height measurement position is located within the inspection region, the autofocus mechanism control unit drives the autofocus mechanism, and when the determination unit determines that the pattern surface height measurement position is not located within the inspection region, the autofocus mechanism control unit stops the autofocus mechanism.

The pattern inspection apparatus according to the present embodiment can drive the autofocus mechanism only within the inspection region specified in advance. Therefore, even when, for example, a mask having a level difference portion between a pattern region and a non-pattern region on a mask surface is adopted as an inspection sample, the focus mechanism does not perform useless operation caused by the effect of the level difference portion, and this eliminates a time lag and erroneous operation due to the useless operation. Therefore, the inspection can be carried out efficiently.

In the explanation below, for example, the inspection sample is a mask for imprint lithography having a level difference portion between a pattern region and a non-pattern region on a mask surface. On the other hand, a mask defect inspection apparatus is explained as an example of a pattern inspection apparatus.

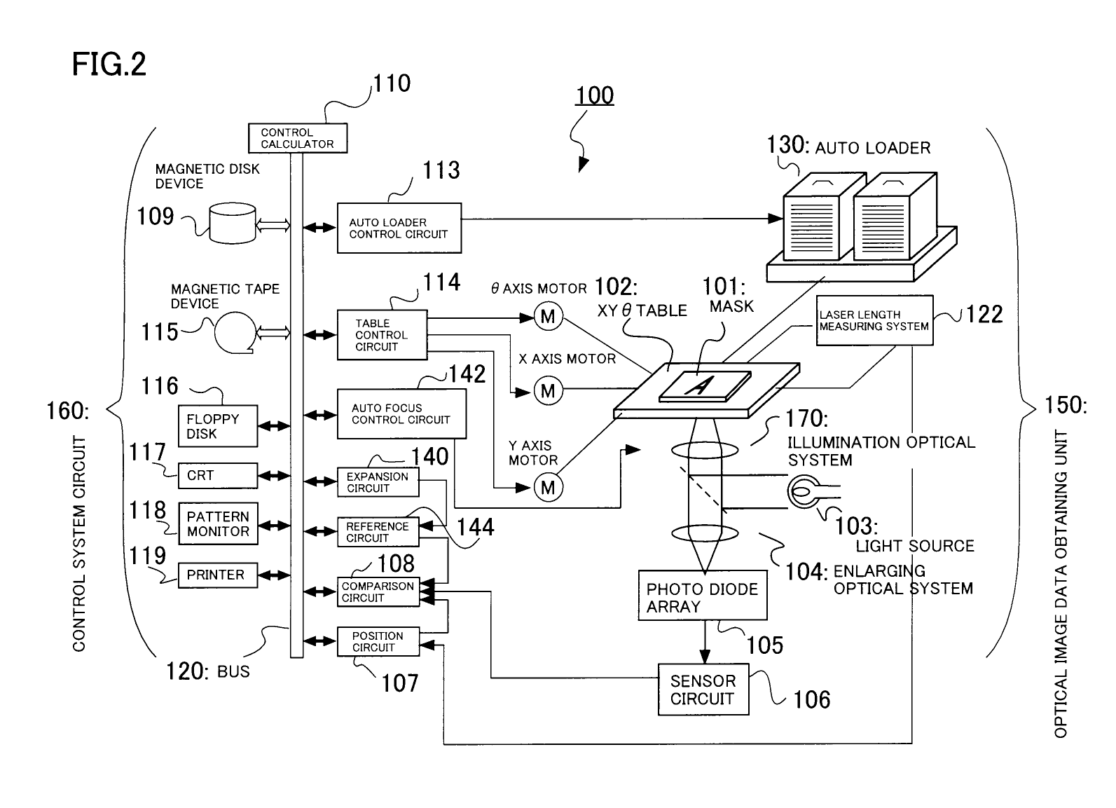

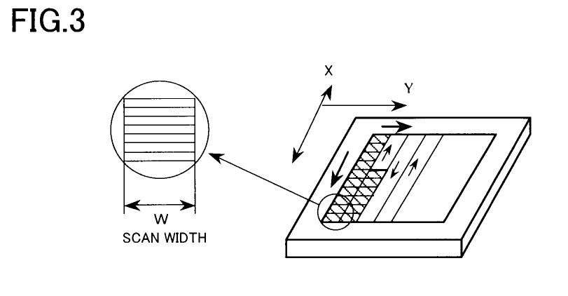

FIG. 2 is a figure illustrating an entire configuration of a pattern inspection apparatus according to the present embodiment. FIG. 3 is an explanatory diagram illustrating inspection of the pattern inspection apparatus according to the present embodiment.

In the mask defect inspection apparatus 100 as shown in FIG. 2, the inspection region in the pattern formed on the mask 101, i.e., the inspection sample, is virtually divided into rectangular inspection stripes having a width W as shown in FIG. 3. Then, the mask 101 is disposed on an XYθ table 102 as shown in FIG. 2, and the inspection is executed while the stage is continuously moved in an X axis direction, so that the divided inspection stripes are continuously scanned. When inspection of one stripe is finished, a step movement in a Y axis direction is performed so that an adjacent stripe is observed. By continuing this operation, linear serpentine-type scan is performed in the present embodiment.

The mask 101 is placed on the XYθ table 102 using an auto loader 130 and an auto loader control circuit 113. The XYθ table 102 is controlled using an X axis motor, a Y axis motor, a θ axis motor, and a table control circuit 114.

An illumination optical system 170 irradiates light emitted by an appropriate light source 103 onto the pattern formed on the mask 101. The light reflected by the mask surface passes through an enlarging optical system 104 and is incident onto a photo diode array 105 serving as an inspection image-capturing means. A portion of a virtually divided rectangular region of the pattern as shown in FIG. 3 forms an optical image on the photo diode array 105 in an enlarged manner. An autofocus control circuit 142 controls autofocus so as to keep defocus to the minimum level on the mask surface in order to maintain preferable imaging state.

The image of the pattern formed on the photo diode array 105 is photoelectric-converted by the photo diode array 105, and is further converted from analog to digital by a sensor circuit 106. The measurement image data output from the sensor circuit 106 as well as data representing the position of the mask 101 on the XYθ table 102 output from the position circuit 107 are transmitted to a comparison circuit 108.

On the other hand, design data used during formation of the pattern of the mask 101 are read from a magnetic disk 109 to an expansion circuit 140 via a control calculator 110. The expansion circuit 140 converts the read design data to binary or multi-value design image data, and the design image data are transmitted to a reference circuit 144. The reference circuit 144 applies appropriate filtering process to the design image data of the transmitted graphic.

The filtering process is also applied to the design image data for matching the measurement pattern data because the measurement pattern data obtained from the sensor circuit 106 are in the state filtered by resolution characteristics of the enlarging optical system 104, the aperture effect of the photo diode array 105, and the like. For this reason, the filtering process is also applied to the design image data, so that the design image data are consistent with the measurement image data. The comparison circuit 108 compares the measurement image data with the design image data subjected to appropriate filtering process according to appropriate algorithm, and when the measurement image data do not match the design image data, the comparison circuit 108 determines that there is defect.

As described above, the mask inspection apparatus according to the present embodiment inspecting defect and foreign particles existing on the pattern formed on the mask surface, i.e., the inspection sample, uses the same optical system as the high-resolution microscope to form a mask pattern image, and obtains the mask pattern image as image information by an image-capturing device such as a line sensor or a CCD camera such as the above photo diode array. Then, the mask inspection apparatus compares the image information with a reference image separately obtained or formed, thereby finding defect or foreign particles in the pattern.

In this case, the mask defect inspection apparatus for comparing the design image data and the measurement image data for defect detection has been explained. Alternatively, the mask defect inspection apparatus may compare pieces of measurement image data with each other.

In this case, the mask defect inspection apparatus having only the reflection illumination optical system for reflection inspection as the illumination optical system has been explained. Alternatively, the mask defect inspection apparatus may further include a transillumination optical system for transmission inspection.

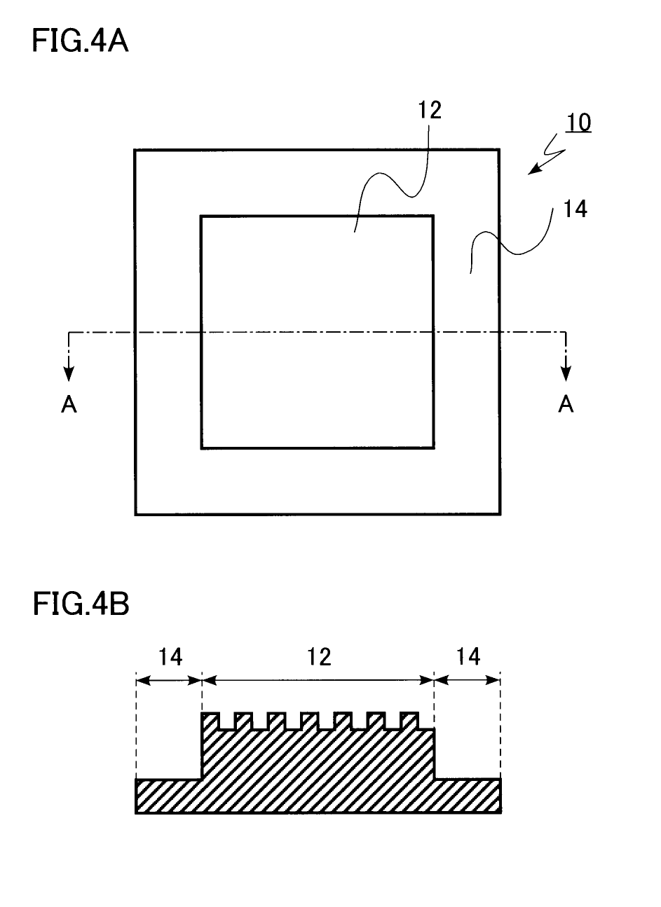

FIGS. 4A and 4B are explanatory diagrams illustrating a mask for imprint lithography serving as inspection sample of the mask defect inspection apparatus according to the present embodiment. FIG. 4A is a top view.

FIG. 4B is a cross sectional view taken along A-A of FIG. 4A.

The mask for imprint lithography 10 includes a pattern region 12 and a non-pattern region 14, and the pattern region 12 is formed to protrude from the non-pattern region 14 by several dozen microns to several hundred microns. In the pattern region, a pattern is formed by concavity and convexity on the surface.

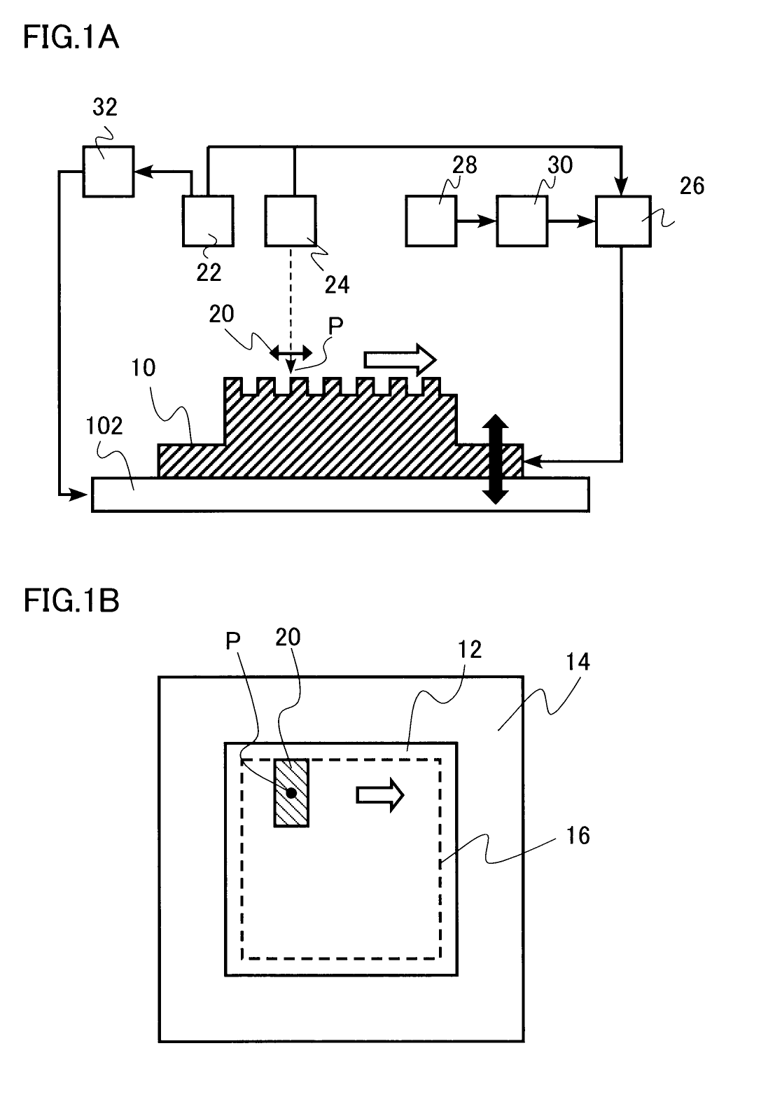

FIGS. 1A, 1B are schematic diagrams illustrating a configuration of an essential portion of the pattern inspection apparatus according to the present embodiment. FIG. 1A is a schematic diagram including a cross section of a mask. FIG. 1B is a schematic diagram seen from the top surface.

As shown in FIG. 1A, the mask defect inspection apparatus according to the present embodiment inspects the mask for imprint lithography 10 disposed on the XYθ table 102. FIG. 1A shows the mask 10 so that the pattern surface (or mask surface) of the mask 10 is at the upper side. In other words, the inspection light is irradiated onto the mask surface from the upper side of the figure.

The pattern inspection apparatus according to the present embodiment includes an inspection region information storage unit 22 storing positional information of inspection region 16 specified in advance within the pattern region 12. For example, the inspection region 16 is a region surrounded by a line located several μm to several mm inside the border line between the pattern region 12 and the non-pattern region 14 in the pattern region. For example, the inspection region information storage unit 22 is constituted by a hard disk.

The method for specifying the inspection region 16 is not particularly limited. For example, the range may be determined on the basis of the design data of the mask, and the range can be stored in the inspection region information storage unit 22 in advance.

In addition, a pattern surface height detection unit 24 is provided to detect, as a pattern surface signal, the pattern surface height with respect to the pattern surface height measurement position P on the inspection sample. For example, the pattern surface height measurement position P is the center of an inspection visual field 20. Alternatively, for example, it may be located in proximity to the inspection visual field 20 outside of the inspection visual field 20.

The pattern surface height detection unit 24 is not particularly limited as long as it has a configuration for detecting the pattern surface height on the mask surface (or pattern surface). For example, a pattern may be provided on a slit for inspection visual field located at a position conjugate with the mask surface, and the amount of light of the pattern is monitored with a sensor provided separately from the photo diode array for detecting the pattern image, whereby the pattern surface height can be detected. Alternatively, an optical system for measuring the pattern surface height provided separately from the one for the inspection light may be used.

Further, an autofocus mechanism 26 is provided to automatically focus on the mask 10 using the pattern surface height signal detected by the pattern surface height detection unit 24. The autofocus mechanism 26 vertically moves the mask 10 with a height adjustment mechanism, not shown, on the basis of the detection result of the pattern surface height on the mask surface as shown by a black both-pointed arrow in FIG. 1A, for example, thus maintaining a desired pattern surface height and focusing. That is, a so-called “focus servo process” is performed.

This enables maintaining preferable imaging state of the pattern image of the mask surface that is formed on the photo diode array. The autofocus circuit 142 as shown in FIG. 2 is a constituent element of the autofocus mechanism 26. It should be noted that the focus adjustment is not necessarily limited to vertically moving the mask 10. Alternatively, for example, the focus adjustment may be done by moving an object lens, an optical lens for focus correction, and the like.

Further, a determination unit 28 is provided to determine whether the pattern surface height measurement position P is located within the inspection region 16 or not. For example, the determination is made using positional relationship between a stage position monitored by a laser length measuring system 122 (FIG. 2) and the specified inspection region 16.

Further, an autofocus mechanism control unit 30 is provided. When the determination unit 28 determines that the pattern surface height measurement position P is located within the inspection region 16, the autofocus mechanism control unit 30 drives the autofocus mechanism 26. On the other hand, when the determination unit 28 determines that the pattern surface height measurement position P is not located within the inspection region 16, the autofocus mechanism control unit 30 stops the autofocus mechanism 26.

Further, an inspection start position setting unit 32 is provided to set the pattern surface height measurement position P within the inspection region 16 at the start of inspection. For example, the inspection start position setting unit 32 has a function of reading the range of the inspection region 16 stored in the inspection region information storage unit 22 and manually or automatically setting the inspection start position. Then, an instruction is given to a table control circuit 114 (FIG. 2) so that the pattern surface height measurement position P is disposed at the position set at the start of inspection, and accordingly, the XYθ table 102 is moved.

The determination unit 28, the autofocus mechanism control unit 30, and the inspection start position setting unit 32 are constituted by, for example, hardware such as a CPU and a circuit board or a combination of hardware and software such as programs.

In addition, a height fixing unit (not shown) and a mask height storage unit (not shown) are desirably provided. The height fixing unit (not shown) fixes the height of the mask 10 when the pattern surface height measurement position P moves from the inside of the inspection region 16 to the outside of the inspection region 16, i.e., when the autofocus mechanism 26 is stopped, on the basis of the result provided by the determination unit 28. The mask height storage unit (not shown) stores the mask height while the autofocus mechanism 26 is activated.

For example, the height fixing unit has a function of fixing the mask height at a height of the mask immediately before the pattern surface height measurement position P moves from the inside of the inspection region 16 to the outside of the inspection region 16. For example, the fixed mask height may be a mask height at the instant when the autofocus mechanism 26 stops or immediately before the autofocus mechanism 26 stops, which are stored in the mask height storage unit, or may be an average height within a certain period of time. When the average height is used, a mask height calculation unit (not shown) is desirably provided to calculate the average height.

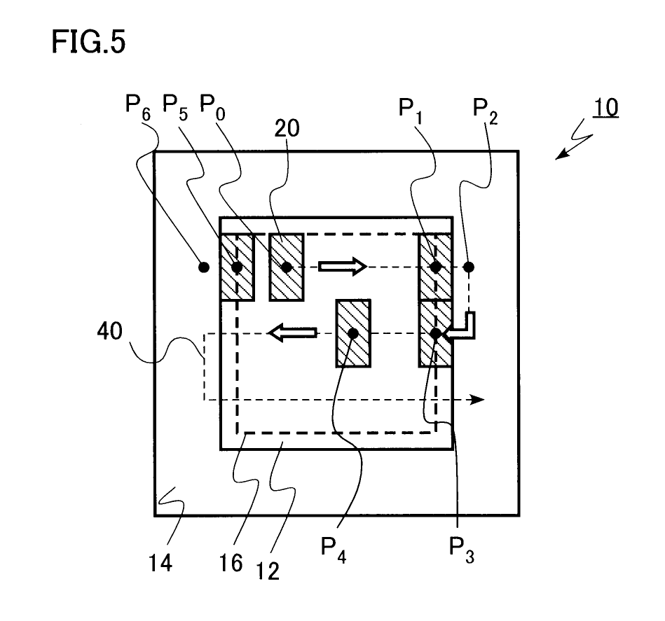

FIG. 5 is a figure illustrating a pattern inspection method according to the present embodiment. Hereinafter, the pattern inspection method according to the present embodiment will be explained also with reference to FIGS. 1A and 1B.

In the mask defect inspection method according to the present embodiment, the mask 10 is inspected by obtaining the pattern image while the XYθ table moves. As shown in a scan path 40, the inspection visual field 20 scans the mask surface with linear serpentine operation, thus obtaining the pattern image.

First, the inspection region 16 is initially set in the pattern region 12 manually or automatically. The inspection region 16 is stored in the inspection region information storage unit 22.

Then, at the start of inspection, the inspection start position setting unit 32 moves the XYθ table 102 so that the pattern surface height measurement position P is disposed within the inspection region 16 stored in the inspection region information storage unit 22. In FIG. 5, a focus measurement position of the start of inspection is denoted by P₀.

The pattern surface height detection unit 24 detects the pattern surface height relative to the pattern surface height measurement position on the mask 10. Then, the autofocus mechanism 26 uses the pattern surface height signal detected by the pattern surface height detection unit to focus on the mask.

The determination unit 28 determines whether the pattern surface height measurement position is located within the inspection region 16 or not. When the pattern surface height measurement position is determined to be located within the inspection region 16, the autofocus mechanism 26 is driven. When the pattern surface height measurement position is determined not to be located within the inspection region 16, the autofocus mechanism 26 is stopped.

At the start of inspection, the pattern surface height measurement position is located at P₀ within the inspection region 16, and therefore, the autofocus mechanism 26 is driven.

When the inspection visual field 20 moves after the start of inspection, and when the pattern surface height measurement position is located within the inspection region 16, the autofocus mechanism 26 is driven, so that focus is adjusted to the mask surface (pattern surface). Then, the inspection visual field 20 once moves back to P₆ to capture an image of the first stripe, but at this occasion the pattern surface height measurement position reaches the edge of the inspection region 16 denoted as P₅, and when the inspection visual field 20 moves out of the inspection region 16, the autofocus mechanism 26 is stopped. At the instant when the autofocus mechanism 26 stops or immediately before the autofocus mechanism 26 stops, the height of the mask is fixed to, e.g., an average height of the mask in a certain period of time before the stop.

Thereafter, scanning of the first stripe starts from P6. When the pattern surface height measurement position reaches the edge of the inspection region 16 denoted as P₅, and the pattern surface height measurement position enters into the inspection region 16, the autofocus mechanism 26, which is stopped, starts operation again, and the focus is adjusted on the mask surface. At this occasion, the autofocus operation returns from the state in which the height is already fixed to the height of the pattern surface. Accordingly, stepwise variation generated during return is reduced to the minimum, and this enables smooth return.

Therefore, when the inspection visual field 20 moves, and while the mask height measurement position stays within the inspection region 16, the autofocus mechanism 26 is driven to focus on the mask surface. Then, when the inspection visual field 20 moves, and the mask height measurement position reaches the edge of the inspection region 16 denoted as P₁, the mask height measurement position falls out of the inspection region 16. At this occasion the autofocus mechanism 26 is stopped. For example, when the mask height measurement position is at the position denoted as P2, the height of the mask is fixed.

Thereafter, scanning starts in the inverse direction. When the pattern surface height measurement position reaches the edge of the inspection region 16 denoted as P₃, and the pattern surface height measurement position enters into the inspection region 16, the autofocus mechanism 26, which is stopped, starts operation again, and the focus is adjusted on the mask surface. Thereafter, while the focus measurement position is within the inspection region 16 as shown by P₄, the autofocus mechanism 26 keeps on operating.

The above operation is repeated according to the scanning of the inspection visual field 20 along the path 40, so that the pattern image is obtained. Then, pattern inspection, i.e., defect inspection of the mask, is performed using the obtained pattern image.

When a pattern image in proximity to a border of the pattern region 12 in a direction perpendicular to the scanning direction of the inspection visual field 20, the image is captured by disposing the inspection visual field 20 at such a position that the pattern surface height measurement position does not fall out of the border of the pattern region 12.

According to the pattern inspection apparatus and the pattern inspection method of the present embodiment, the autofocus mechanism will not be driven in the non-pattern region 14 having a large difference of level with respect to the pattern region 12. Therefore, also in the scanning of the linear serpentine operation, there is no time lag caused by useless operation of the autofocus mechanism caused by the effect of the level difference portion of the mask, such as focus servo process for focusing on the non-pattern region 14 or waiting for re-focusing on the pattern region 12 due to the focus servo process for focusing on the non-pattern region 14, and therefore, efficient inspection can be achieved. In addition, a problem of erroneous operation of the autofocus mechanism that causes the apparatus to stop does not occur.

### Second Embodiment

The second embodiment is the same as the first embodiment except that the apparatus of the second embodiment further includes a low magnification image obtaining unit capable of obtaining an image of a lower magnification than a pattern image and an inspection region specifying unit for specifying an inspection region from an image obtained by the low magnification image obtaining unit. Therefore, descriptions about overlapping contents with the first embodiment will be omitted.

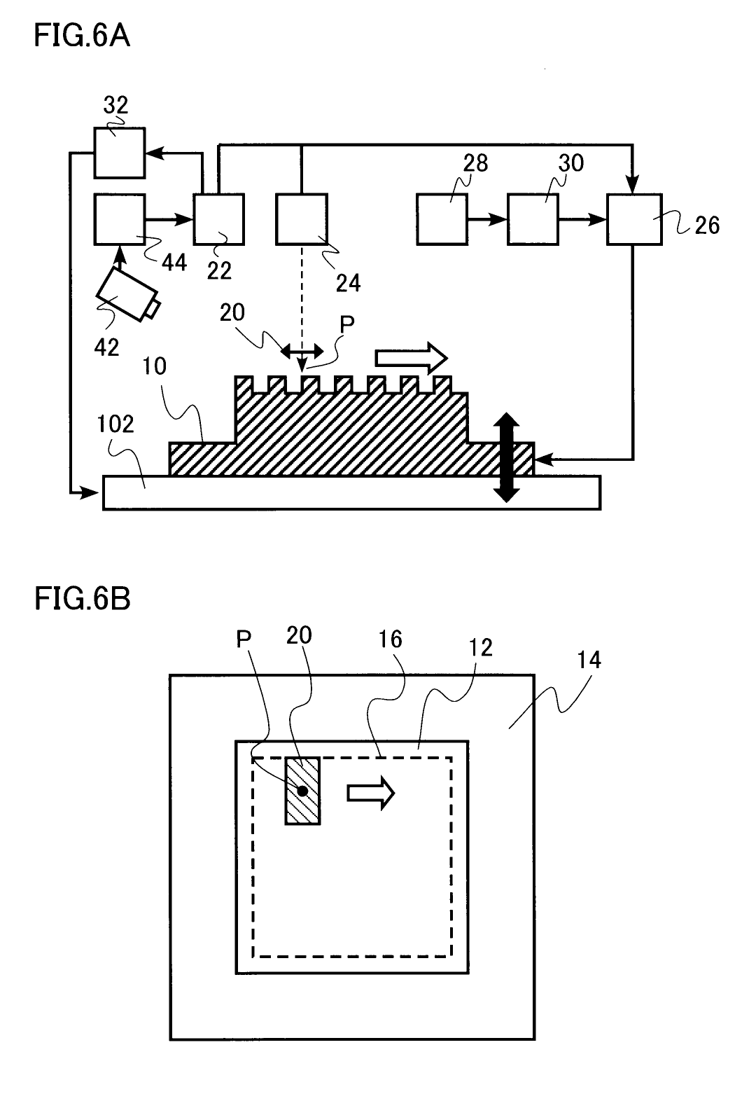

FIGS. 6A and 6B are schematic diagrams illustrating a configuration of an essential portion of a pattern inspection apparatus according to the present embodiment. FIG. 6A is a schematic diagram including a cross section of a mask. FIG. 6B is a schematic diagram seen from the upper surface.

The pattern inspection apparatus according to the present embodiment includes a low magnification image obtaining unit 42 capable of obtaining an image of a lower magnification than a pattern image used for inspection. In addition, the pattern inspection apparatus according to the present embodiment includes an inspection region specifying unit 44 for specifying an inspection region 16 from the image obtained by the low magnification image obtaining unit 42.

For example, the low magnification image obtaining unit 42 is a camera whose magnification is about 1× to 64×, and is configured to focus on a mask surface without any autofocus mechanism since the focal depth is deep. The inspection region specifying unit 44 manually or automatically sets the inspection region 16 from the image obtained by the low magnification image obtaining unit 42.

For example, the inspection region 16 can be specified by specifying a range using a cursor and the like on an image taken by the camera of the low magnification. For example, a pattern region 12 may be automatically recognized from the image taken by the camera of the low magnification, and a rectangular region inside the edge of the pattern region 12 by a predetermined dimension may be automatically specified as the inspection region 16.

The specified inspection region 16 is stored in the inspection region information storage unit 22.

In the pattern inspection method according to the present embodiment, prior to obtaining the pattern image, the low magnification image obtaining unit 42 captures an image of the mask surface and the inspection region specifying unit 44 specifies the inspection region 16.

According to the pattern inspection apparatus and the pattern inspection method of the present embodiment, the inspection region is specified on the basis of the image taken by the camera. Therefore, the inspection region can be specified with a higher accuracy. Therefore, for example, the determination unit can make determination with a higher accuracy. In addition, for example, the inspection region can be specified up to a position very close to the edge of the pattern region.

### Third Embodiment

A pattern inspection apparatus according to the present embodiment is a pattern inspection apparatus for inspecting an inspection sample using a pattern image obtained by emitting light onto the inspection sample placed on a stage and having a pattern region having a pattern formed therein and a non-pattern region surrounding the pattern region and having no pattern formed therein. In addition, the pattern inspection apparatus according to the present embodiment includes a height measuring unit for measuring heights at three positions on a pattern surface formed by a pattern region, an inclination calculation unit for calculating an inclination of the pattern surface from the measurement result provided by the measuring unit, a correction value calculation unit for calculating a correction value for causing the inclination of the pattern surface and the inclination of the run surface of the stage (or XYθ table) to be the same, from the calculation result provided by the inclination calculation unit, and an inclination correction mechanism for causing the inclination of the pattern surface and the inclination of the stage run surface to be the same using the correction value.

The pattern inspection apparatus according to the present embodiment can cause the inclination of the pattern surface and the inclination of the stage run surface to be the same. Therefore, when the focus is adjusted at one point on the pattern surface, a focused pattern image can be obtained without adjusting the focus during inspection.

Description about the same contents about the pattern inspection apparatus and the pattern inspection method as those of the first embodiment are omitted in the explanation below.

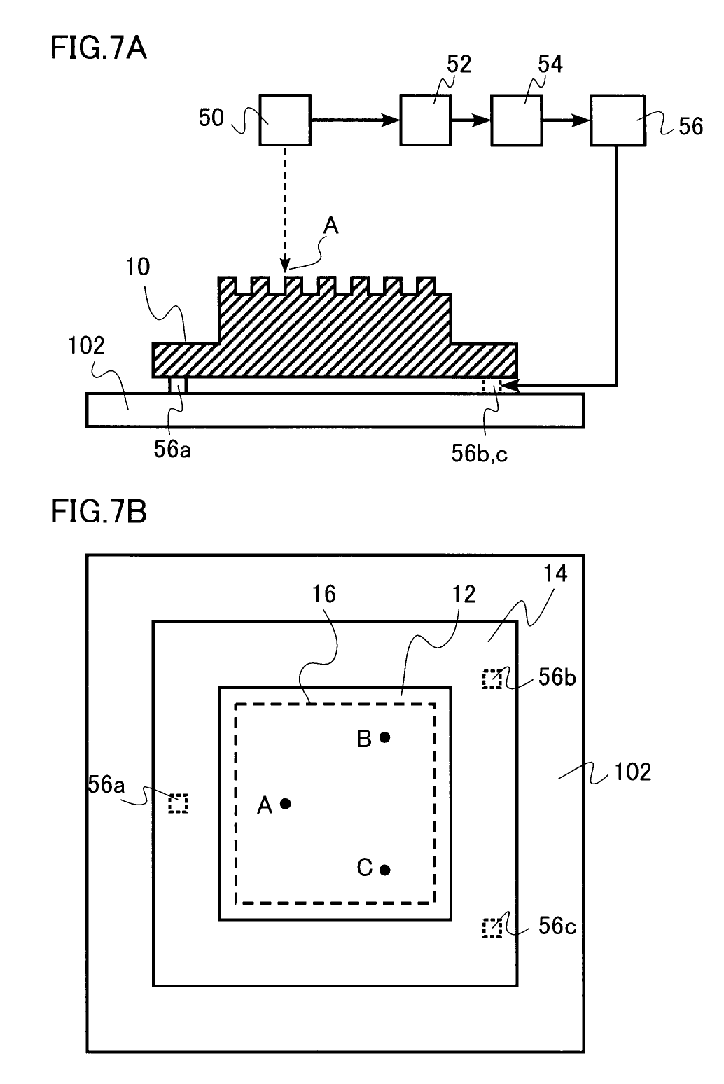

FIGS. 7A and 7B are schematic diagrams illustrating a configuration of an essential portion of a pattern inspection apparatus according to the present embodiment. FIG. 7A is a schematic diagram including a cross section of a mask. FIG. 7B is a schematic diagram seen from the top surface.

As shown in FIG. 7A, the mask defect inspection apparatus according to the present embodiment inspects a mask for imprint lithography 10 disposed on the XYθ table 102. FIG. 7A shows the mask 10 so that the pattern surface (or mask surface) of the mask 10 is at the upper side. In other words, the inspection light is irradiated onto the mask surface from the upper side of the figure.

The pattern inspection apparatus according to the present embodiment includes a height measuring unit 50 capable of measuring heights at three positions on the pattern surface formed by the pattern region, e.g., heights at A, B, and C in FIG. 7. By measuring at least three positions on the pattern surface, the pattern surface can be defined in an XYZ coordinate system allocated for the pattern inspection apparatus.

As long as the height measuring unit 50 can measure the heights at three positions A, B and C on the pattern surface, the height measuring unit 50 may have any configuration. For example, the height measuring unit 50 may be configured to measure the heights at three positions A, B, and C by using a pattern surface height detection unit for detecting a pattern surface height, a height position monitor unit of the stage, and a stage height movement mechanism. For example, the height measuring unit 50 may be configured to measure the heights at three positions A, B, and C by using a laser interferometer.

Further, an inclination calculation unit 52 is provided to calculate an inclination of the pattern surface from the measurement result provided by the height measuring unit 50. The inclination calculation unit 52 calculates the inclination of the pattern surface in the XYZ coordinate system allocated for the pattern inspection apparatus.

In addition, the pattern inspection apparatus according to the present embodiment includes a correction value calculation unit 54 for calculating a correction value for causing the inclination of the pattern surface and the inclination of the run surface to be the same, from the calculation result provided by the inclination calculation unit 52. The correction value calculation unit 54 calculates the correction value for causing the inclination of the pattern surface and the inclination of the run surface to be the same, i.e., the correction value of the height of the mask 10 that is needed to make the two surfaces in parallel.

In this case, the stage run surface means a surface formed by any point on the stage or on the XYθ table when the stage runs in the XY direction. The stage run surface is a known plane in parallel to a plane of a platen on which the stage (XYθ table 102) is placed. Therefore, the stage run surface can be defined in the XYZ coordinate system allocated for the pattern inspection apparatus.

Therefore, the inclination of the stage run surface of the above XYZ coordinate system can be calculated in advance. For example, in a possible configuration, a run surface inclination storage unit may be provided to store the inclination of the stage run surface.

In addition, the pattern inspection apparatus according to the present embodiment includes the inclination correction mechanism for causing the inclination of the pattern surface and the inclination of the run surface to be the same, i.e., making the pattern surface and the run surface of the stage in parallel to each other, using the correction value calculated by the correction value calculation unit 54. The inclination correction mechanism is not particularly limited as long as it is configured to relatively change the inclination of the pattern surface with respect to the inclination of the run surface.

For example, as shown in FIGS. 7A and 7B, the inclination correction mechanism includes three piezo elements 56a, 56b, and 56c provided between the XYθ table 102 and the mask 10, a displacement monitor (not shown) for monitoring displacement of each of the piezo elements 56a, 56b, and 56c, and a inclination correction control unit 56 for controlling the piezo elements. In this configuration, the mask height on the stage is corrected at three points, and therefore, the inclination of the pattern surface and the inclination of the stage run surface can be made the same.

For example, the correction value calculated by the correction value calculation unit 54 includes heights to be corrected by the three piezo elements 56a, 56b, and 56c.

When the inclination of the pattern surface and the inclination of the run surface are made the same, the correction is made so that a pattern image focused on at least one point on the pattern surface can be captured.

In the present embodiment, a pattern surface height monitor unit (not shown) is desirably provided to monitor the pattern surface height on the inspection sample. When the pattern surface height monitor unit is provided, for example, it is possible to detect defocus caused by displacement of the inclination of the pattern surface of the mask and the inclination of the run surface of the stage during inspection.

The inclination calculation unit 52, the correction value calculation unit 54, and the inclination correction control unit 56 are constituted by, for example, hardware such as a CPU and a circuit board or a combination of hardware and software such as programs.

Like the first embodiment, the present embodiment is also desirably configured to include an inspection region information storage unit storing an inspection region 16 specified in advance within the pattern region 12. In this configuration, the three positions A, B, and C on the pattern surface within the stored inspection region 16 can be easily determined, and the heights can be measured easily.

Further, like the second embodiment, the present embodiment desirably includes a low magnification image obtaining unit capable of obtaining an image of a lower magnification than a pattern image and an inspection region specifying unit for specifying an inspection region from an image obtained by the low magnification image obtaining unit, so that the inspection region can be specified with a higher accuracy.

Hereinafter, the pattern inspection method according to the present embodiment will be explained with reference to FIGS. 7A and 7B.

First, before the inspection, the inclination of the stage run surface in the XYZ coordinate system allocated for the pattern inspection apparatus is calculated.

Subsequently, the mask 10 is placed on the stage (XYθ table 102). Thereafter, the height measuring unit 50 measures the heights of the three positions A, B, and C in the pattern region of the mask.

Subsequently, the inclination calculation unit 52 calculates each of the inclinations of the pattern surface in the XYZ coordinate system allocated for the pattern inspection apparatus.

Subsequently, the correction value calculation unit 54 calculates the correction value for causing the inclination of the pattern surface and the inclination of the stage run surface to be the same, from the calculation result provided by the inclination calculation unit 52.

Subsequently, the inclination correction mechanism causes the inclination of the pattern surface and the inclination of the stage run surface to be the same, using the correction value calculated by the correction value calculation unit 54. In other words, the pattern surface and the stage run surface are made parallel to each other. At this occasion, the correction is made so that a pattern image focused on at least one point on the pattern surface can be captured.

Thereafter, inspection starts. In the inspection, the inspection visual field is scanned on the mask surface, and the pattern image is captured. Defect of the mask is examined using the pattern image.

It should be noted that the pattern surface height monitor unit desirably monitors the pattern surface height so as to determine whether defocus occurs during the inspection. When the pattern surface height is monitored, for example, the inspection can be temporarily stopped if defocus is detected, so that measures can be taken, e.g., the inclination of the pattern surface of the mask can be corrected again. This enhances the efficiency and the accuracy of the inspection.

According to the pattern inspection apparatus and the pattern inspection method of the present embodiment, the focused pattern image of the entire pattern region 12 can be captured without using any autofocus mechanism. Therefore, this can solve problems such as time lag and erroneous operation caused by the level difference portion formed at the border portion between the pattern region 12 and the non-pattern region 14 during inspection using the autofocus mechanism.

The embodiments have been hereinabove explained with reference to specific examples. However, the present invention is not limited to these specific examples.

In the above explanation, for example, the mask for imprint lithography is explained as an example of the inspection sample. However, the present invention can also be applied to other masks as long as the mask has a level difference portion between a pattern region and a non-pattern region.

Portions that are not directly needed for the explanation about the present invention, such as an apparatus configuration and a control method, are omitted in the description. However, an apparatus configuration and a control method that are needed may be selected and used as necessary. In addition, all pattern inspection apparatuses that have the elements of the present invention and can be made by a person skilled in the art through design change applied as necessary are included in the scope of the present invention.

What is claimed is:

1. A pattern inspection apparatus configured to inspect an inspection sample using a pattern image obtained by emitting light onto the inspection sample having a pattern region having a pattern formed therein and a non-pattern region surrounding the pattern region and having no pattern formed therein, the pattern inspection apparatus comprising:
an inspection region information storage unit configured to store a positional information of inspection region specified in the pattern region;
a pattern surface height detection unit configured to detect a pattern surface height signal at a pattern surface height measurement position on the inspection sample;
an autofocus mechanism configured to focus on the inspection sample using the pattern surface height signal detected by the pattern surface height detection unit;
a determination unit configured to determine whether the pattern surface height measurement position is located within the inspection region or not; and
an autofocus mechanism control unit,
wherein, when the determination unit determines that the pattern surface height measurement position is located within the inspection region, the autofocus mechanism control unit drives the autofocus mechanism, and
when the determination unit determines that the pattern surface height measurement position is not located within the inspection region, the autofocus mechanism control unit stops the autofocus mechanism.

2. The pattern inspection apparatus according to claim 1, further comprising an inspection start position setting unit configured to set the pattern surface height measurement position at a start of inspection within the inspection region.

3. The pattern inspection apparatus according to claim 1, further comprising:
a low magnification image obtaining unit capable of obtaining an image of a lower magnification than the pattern image; and
an inspection region specifying unit configured to specify the inspection region from the image obtained by the low magnification image obtaining unit.

4. The pattern inspection apparatus according to claim 1, wherein the inspection region information storage unit stores positional information of inspection region specified on the basis of design data of the pattern.

5. The pattern inspection apparatus according to claim 1, wherein the determination unit makes determination using positional relationship between a stage position monitored by a laser length measuring system and the specified inspection region.

6. The pattern inspection apparatus according to claim 1, further comprising:
a fixing unit configured to fix a height of the inspection sample when the autofocus mechanism is stopped; and
an inspection sample height storage unit configured to store a height of the inspection sample during operation of the autofocus mechanism.

7. The pattern inspection apparatus according to claim 1, wherein the inspection sample is a mask for imprint lithography.

8. A pattern inspection apparatus configured to inspect an inspection sample using a pattern image obtained by emitting light onto the inspection sample placed on a stage and having a pattern region having a pattern formed therein and a non-pattern region surrounding the pattern region and having no pattern formed therein, the pattern inspection apparatus comprising:
a height measuring unit configured to measure heights at three positions on a pattern surface formed by the pattern region;
an inclination calculation unit configured to calculate an inclination of the pattern surface, from a measurement result provided by the height measuring unit;
a correction value calculation unit configured to calculate a correction value to cause an inclination of the pattern surface and an inclination of the stage run surface to be the same, from a calculation result provided by the inclination calculation unit; and
an inclination correction mechanism configured to cause the inclination of the pattern surface and the inclination of the stage run surface to be the same, using the correction value.

9. The pattern inspection apparatus according to claim 8, further comprising a pattern surface height monitor unit configured to monitor a pattern surface height on the inspection sample.

10. The pattern inspection apparatus according to claim 8, further comprising a run surface inclination storage unit configured to store an inclination of the stage run surface.

11. The pattern inspection apparatus according to claim 8, wherein the inclination correction mechanism comprises three piezo elements provided between the stage and the inspection sample, a displacement monitor configured to monitor displacement of each of the piezo elements, and an inclination correction control unit configured to control the piezo elements.

12. The pattern inspection apparatus according to claim 8, wherein the correction value is a height to be corrected by the piezo element.

13. The pattern inspection apparatus according to claim 8, further comprising an inspection region information storage unit configured to store an inspection region specified in the pattern region.

14. The pattern inspection apparatus according to claim 8, further comprising:
a low magnification image obtaining unit capable of obtaining an image of a lower magnification than the pattern image; and
an inspection region specifying unit configured to specify the inspection region from the image obtained by the low magnification image obtaining unit.

15. The pattern inspection apparatus according to claim 8, wherein the inspection sample is a mask for imprint lithography.
